(19) United States
(12) Patent Application Publication
(10) Pub. No.: US 2014/0279057 A1
(43) Pub. Date: Sep. 18, 2014

(54) METHOD OF AUTOMATICALLY VISUALIZING CONTENT AND MESSAGING OF DOCUMENTS IN A MARKETING CAMPAIGN DESIGN ENVIRONMENT

(71) Applicant: XEROX CORPORATION, Norwalk, CT (US)

(72) Inventors: Michael David Shepherd, Ontario, NY (US); Dale Ellen Gaucas, Penfield, NY (US); Kirk J. Ocke, Ontario, NY (US)

(73) Assignee: XEROX CORPORATION, Norwalk, CT (US)

(21) Appl. No.: 13/826,438

(22) Filed: Mar. 14, 2013

(51) Int. Cl. G06Q 30/02

(52) U.S. Cl. CPC G06Q 30/0276
USPC 705/14.72

(57) ABSTRACT

A method of automatically visualizing the content and messaging of documents in a marketing campaign design environment are provided. The exemplary method includes receiving an identification of a specified Touchpoint of the plurality of Touchpoints in a campaign; instantiating the specified Touchpoint and its elements into a knowledge model; executing semantic inferencing engine to determine inferences based on the plurality of Touchpoints instantiated into the knowledge model; transforming inferences into implicit requirements about the contents for each of the Touchpoints; displaying a representation of the specified Touchpoint; and including within the representation of the specified Touchpoint the Touchpoint contents as described by the explicit and implicit requirements.

### BACKGROUND

Aspects of the exemplary embodiment relate to communications systems configured to help users create and send communications. Other aspects relate, e.g., to personalized marketing campaign design systems.

By way of background, personalized communications systems may be used to create Personalized Marketing Campaigns, such as Variable Data Marketing Campaigns, allow a user to design communications that contain information tailored specifically for each recipient. Such communications include several possible pre-defined campaign products, such as mailings, flyers, postcards, electronic mail blasts, and the like. Presently, marketers, designers, and print providers can create such campaigns within the structure provided by various products designed to aid in the creation of those campaigns. Such users must use a pre-defined lexicon of terms that is accepted and understood by the campaign design products, and the products lack the ability to provide guidance and feedback to the user.

In this regard, a knowledge model has been created that captures all the various elements that a marketing campaign can consist of. These elements include such concepts as Touchpoints, Messages, Calls to Action, Incentives, Campaign Objectives, Timing, and the like. The knowledge model provides a structured means in which to represent a marketing campaign. The campaign's structured representation via the knowledge model can then be used to automatically determine the types of content and messaging that should appear in the document of each Touchpoint in the campaign.

However, there is a need for a method of providing a simple rendering of the content and messaging that can be generated and shown to the graphic designer to ensure they correctly capture all needed document content in the graphic design.

### BRIEF DESCRIPTION

In one aspect of the exemplary embodiment, a computer-implemented method of automatically generating a template, example, or outline of a document in a marketing campaign design environment, is provided. The method includes receiving an identification of a specified Touchpoint of the plurality of Touchpoints in a campaign; instantiating the specified Touchpoint and its elements into a knowledge model; using a semantic inferencing engine to determine inferences based on the plurality of Touchpoints instantiated into the knowledge model; transforming inferences into implicit requirements about the contents for each of the Touchpoints; displaying a representation of the specified Touchpoint; and/or including within the representation of the specified Touchpoint the Touchpoint contents as described by the explicit and implicit requirements.

In another aspect of the exemplary embodiment, a system for automatically generating a template, example, or outline of a document in a marketing campaign design environment is provided. The system includes: one or more processors configured for: receiving an identification of a specified Touchpoint of the plurality of Touchpoints in a campaign; instantiating the specified Touchpoint and its elements into a knowledge model; using a semantic inferencing engine to determine inferences based on the plurality of Touchpoints instantiated into the knowledge model; transforming inferences into implicit requirements about the contents for each of the Touchpoints; displaying a representation of the specified Touchpoint; and/or including within the representation of the specified Touchpoint the Touchpoint contents as described by the explicit and implicit requirements

In yet another aspect, a non-transitory computer-usable data carrier is provided. The non-transitory computer-usable data carrier stores instructions that, when executed by a computer, cause the computer to perform a method of automatically generating a template, example, or outline of a document in a marketing campaign design environment. The method comprises: receiving an identification of a specified Touchpoint of the plurality of Touchpoints in a campaign; instantiating the specified Touchpoint and its elements into a knowledge model; using a semantic inferencing engine to determine inferences based on the plurality of Touchpoints instantiated into the knowledge model; transforming inferences into implicit requirements about the contents for each of the Touchpoints; displaying a representation of the specified Touchpoint; and/or including within the representation of the specified Touchpoint the Touchpoint contents as described by the explicit and implicit requirements.

In certain embodiments, the implicit requirements may include, for example, auto generating a natural language message describing a campaign recipient's calls-to-action, a performance of which will entitle a performer to the incentive, auto selecting sample messaging describing the inferred Touchpoint type, automatically determining the visualization template in which to use that corresponds to the explicit and implicit requirements, and/or the inferred Touchpoint elements such that the campaign conforms to marketing best practices. Further, the marketing best practices may comprise the automated inference that information about the Incentive appears on each Touchpoint in the campaign, or that campaign response tracking automatically infers that a bar code or invitation code must appear on a Touchpoint. Also, certain embodiments may further include displaying respective annotations associated with respective portions of the auto generated content and natural language messaging, wherein the annotations identify at least one of a source of and a reason for, the inclusion of the respective portion of the auto generated content and natural language messaging.

### BRIEF DESCRIPTION OF THE DRAWINGS

FIG. 1 is a block diagram depicting an apparatus that creates a personalized marketing campaign, including the automatic detection of errors and inconsistencies;

FIG. 2 is a flowchart of a process for the creation of personalized marketing campaigns which shows interaction between the workflow and the marketing campaign knowledge model, including the automatic detection of errors and inconsistencies;

FIG. 3 is a block diagram depicting a user interface used by a user to construct a personalized marketing campaign using an unstructured campaign workflow;

FIG. 4 is a flowchart of an example process for drawing an inference from semantic data entered by the user and guiding the user in the creation of the marketing campaign based on that inference;

FIG. 5 is a block diagram depicting an exemplary personalized marketing campaign workflow case study;

FIG. 6 is a flowchart of an exemplary method of automatically generating a template, example, or outline of a document in a marketing campaign design environment; and

FIG. 7 depicts a sample rendering of a Touchpoint in a campaign workflow in accordance with aspects of the exemplary method.

### DETAILED DESCRIPTION

For a general understanding of the present disclosure, reference is made to the drawings. In the drawings, like reference numerals have been used throughout to designate identical elements.

Compliance with the structural and lexicographic requirements of personalized marketing campaign design programs makes the creation of variable data campaigns complicated and time consuming. The use of the disclosed apparatus and methods in the creation of marketing campaigns allows for automated guidance for the design of personalized marketing campaigns. The automated structure can be grounded by the campaign knowledge model and can use reasoning systems to ensure consistency of vocabulary. This is especially useful for collaborative creation of variable data campaigns by multiple collaborators. The automated structure grounded by the campaign knowledge model and using the reasoning systems can ensure a consistent vocabulary among the collaborators, can check for consistency among the campaign's various components, and detect errors as the campaign is constructed by the collaborators, as well as suggest campaign components.

An apparatus for the creation of personalized marketing campaigns, such as variable data marketing campaigns may include an inference engine and automated reasoning system to guide users through the creation of the campaign. Such assistance can include automatically suggesting components and/or information for the user to include in the campaign, automatically checking for inconsistencies across the campaign components, and automatically detecting likely user errors in the construction of the campaign. The user may be automatically alerted of such errors and/or inconsistencies, and can be automatically notified of the components and/or information suggested for inclusion. Detected errors, inconsistencies, or missing information, etc., may be automatically corrected without any notification to the user. The user can select whether the user wishes to be alerted to such changes, or whether the user prefers to have such changes automatically entered. The user can choose to be alerted to some types of changes, and to have others occur automatically.

The campaign design process can be simplified by drawing inferences regarding the campaign being designed, based on the campaign design data input by a user. The campaign design process is simplified by allowing for an unstructured approach by which the user could plan, review, and execute a personalized variable data campaign workflow. For example, one or more free-form text fields can be provided in which the user could describe the content and context of a marketing campaign using natural language.

An inference engine uses automatic reasoning to create a system capable of semantic inference from the natural language data entered by a user, where such inferences are based on the semantic definitions of concepts of marketing campaigns stored in a knowledge database. This allows for a structured, but semantic approach to the personalized creation of variable data marketing campaigns, either by an individual or by a collaborative group. Without such an inference engine, collaboration between multiple users is difficult, in part because of errors and inconsistencies in the vocabulary used by the various collaborators on a campaign.

The inference engine uses an automated reasoning system to automatically draw inferences from comparisons of the data supplied by a user and data stored in a knowledge database. The inferences drawn by the inference engine can be communicated to the user, and can be used to facilitate the creation of the campaign. The inferences can be used to check for errors or inconsistencies in the campaign, to ensure a consistent vocabulary, and to suggest additional actions the user may take in the creation of the campaign.

The automatic suggestions and consistency checking is accomplished with the use of a campaign knowledge model and inferencing engine that captures the know-how of personalized campaign creation. Through knowledge engineering of the real-world concepts, relationships, and structure of personalized marketing campaigns, a knowledge representation is constructed that is usable by automated reasoning systems (such as open world reasoners and rule-based systems) that results in a system capable of semantic inference unique to marketing campaigns. The result of the reasoning system's application to the knowledge representation is, in embodiments, apparatus and methods capable of semantic inference unique to marketing campaigns.

An engine draws inferences, at least in part, by considering data regarding the design of other marketing campaigns stored in a knowledge database. The knowledge database may contain encoded concepts extracted from complete personalized marketing campaigns, and semantic definitions of those concepts. The data may be knowledge engineered from existing complete personalized marketing campaigns. Through the knowledge engineering, personalized marketing campaign concepts are identified, and semantic definitions of those concepts are created.

The campaign components include concepts such as Touchpoints with the campaign targets, the messages being conveyed to the targets, the relationships between the Touchpoints that define the campaign workflow, and the campaign's business objective. Concepts identified from such existing personalized marketing campaigns can be, for example:
a. Business Objectives
b. Calls-to-action
c. Campaign Types, (i.e. campaign semantically classified as being targeted to a particular vertical market (e.g., Healthcare, Education, Retail etc.), to achieve a particular Business Objective, etc.)
d. Channels
e. Data Categories
f. Data Sets
g. Data Sources
h. Events
i. Human Actions
j. Incentives
k. Informational Content
l. Messages
m. Recipient Type
n. Timing
o. Touchpoints
p. Tracking
q. Vertical Markets

Each concept can be further subdivided into subconcepts. For example, “Messages” can include subcategories of confirmations, donations requests, invitations, product offers, registrations, solicitations, teasers, and “thank you” messages. Each of these concepts may be semantically defined, and those semantic definitions may be encoded and loaded into the knowledge database.

When the user enters data that matches a semantic definition of a concept in the knowledge database, the inference engine draws the inference that the user is attempting to add that identified personalized marketing campaign concept to the user's campaign design. Guidance, instructions, or suggestions for the design of a successful personalized marketing campaign with the identified concept can then be communicated to the user. Alternatively, in embodiments, a complete campaign design incorporating the identified concepts can be suggested to the user.

As one example, where a user enters data matching the semantic definition of the campaign concept “Message”, such as text reading “send thank you”, the user can be presented with suggestions, for example, as to whom such messages are often sent in the type of campaign the user is designing, or what information is often included in such a message, e.g., address information. Similar suggestions can be made for each concept identified as the user enters data for the creation of the campaign.

Conversely, where the user has not entered data matching the semantic definition, but instead enters or selects the concept itself; i.e., in the example above the user entered “Message”, the inference engine can infer the semantics of the message based on its context within the campaign. For example, if the user enters “send Message” or selects “Message” from a menu of selectable concepts, the system can infer that the user is attempting to create a “Thank you” message based on where the message occurs in the campaign workflow, and can suggest, for example, appropriate content, actions, timing, and/or recipients. Again, similar suggestions can be made for each campaign concept as the user enters data for the creation of a campaign. One approach for providing a structured, semantic workflow for the collaborative creation of personalized marketing campaigns is described below.

Multiple case studies, for example approximately twenty case studies, of successful personalized marketing campaign may be knowledge engineered to extract and represent the various types of content in each campaign. Examples of such case studies have been published by PODi, the Digital Printing Initiative. The semantic concepts within each campaign may be captured and represented along with the campaign contents into a knowledge model. The knowledge modeling language chosen may have the capability to 1) use Description Logics to encode semantic definitions of the campaign concepts; 2) use an automated reasoning system to infer semantic meaning of campaign content; and 3) use rules and queries to further infer additional (non-asserted) knowledge about campaigns during their creation. An example of such a language that may be used, in embodiments, is OWL (the Web Ontology Language) for knowledge representation and SPARQL (Simple Protocol and RDF Query Language) for knowledge query and SWRL (Semantic Web Rule Language) for knowledge inferencing. Campaign concepts captured in the knowledge model may include, for example: “Calls-to-action”, “Touchpoints”, “Messages”, “Incentives”, “Business Objectives”, “Communication Channels”, and “Recipient Lists”, etc.

Most campaign concepts have their own taxonomy. For instance, a campaign “Message” can be of one or more types of messages, including, but limited to, an “Invitation”, a “Product Offer”, a “Registration”, a “Request for Information”, a “Thank You”, and the like. Specific types of Touchpoints may include, for instance, “Meetings” or “Reminders”.

The terminology and semantic definitions can be engineered directly out of campaign case studies, such as the studies described above. Semantic definitions can be encoded, for example, using a First Order Logic, such as Description Logics, so that automated semantic reasoners are able to determine to which concepts any particular instantiated instance belongs. For instance, as a user is creating their campaign workflow, they may create instances of campaign elements, such as, for example, Touchpoints, Messages, Content that appears in the documents for a particular channel (e.g., e-mail, web, print, etc.). As this information is instantiated into the knowledge model, the automated reasoning infers additional information about the campaign workflow that may be of interest to the user. This new information may then be conveyed back to the user through the user interface. Some examples of what the new information may consist of include: new concepts that describe the campaign element; new node detail added to the campaign element; validation warnings attributed to the workflow; and suggestions to the user about adding new workflow content.

The representation of the actual case studies in the knowledge model as instances of campaign workflow also provides for the intelligent automated extraction of suggestions to be made to the user that are based on real-world successful marketing campaigns. Some examples of use cases for marketing campaign creation that can be automated in certain embodiments using the approach described herein include:
offering an enumerated list of “Calls-to-action” (seeking actions from a recipient) that are relevant for the particular type of “Messages” (e.g. Invitation provides potential Calls-to-action such as Visit PURL (Personalized URL), Visit Store, Visit Web Site, etc.);
inferring the particular type of Message based on the Calls-to-action provided by the user (e.g. inferring that a Message is an invitation based on user input of text such as “Visit Store” as a Call-to-Action);
Recommending additional Touchpoints to add to the campaign workflow based on analysis of the successful case studies (e.g., recommending that the user send a “Thank You” Message when the recipient responds to an Invitation Message);
automatically checking that initial workflow steps provide all the information content required by later workflow steps. (e.g. checking that a user has provided a Phone Number in a previous Touchpoint when setting up a teleconference Meeting, or that all necessary recipient address information has been provided in a previous Touchpoint when the user prepares to send a Postcard.);
automatically synchronizing informational content between related Touchpoints (e.g., in cases where a Touchpoint is inferred by the inference engine to be a Reminder Touchpoint, the Reminder Touchpoint would automatically include the same Message information as the previous initial Touchpoint's Message.);
inferencing of the most commonly used data categories in the campaign for a particular identified campaign type (for instance the inference engine identifies that the user is creating an Education campaign type, and therefore should typically include, for example, recipient data of College Major, Donor Status, Graduation Year, Favorite Professor, and that a Retail campaign typically includes recipient data such as Historical Spending, Shopping Frequency, Date of Last Visit, Book Genre Preference.); and/or
automatically checking the Temporal Consistency between workflow items (e.g., a Reminder to redeem a Coupon must not occur after Coupon expiration).

Referring now to the drawings in greater detail, FIG. 1 shows a block diagram of an apparatus 100 suitable for creating a personalized marketing campaign, including the automatic detection of errors and inconsistencies. The use of the apparatus 100 in the creation of marketing campaigns, especially in a collaborative environment, provides the campaign collaborators with an automated structure in which to construct the marketing campaigns.

One or more users are presented a user interface 102, such as a graphical user interface, on a user computer 104 with a monitor. The one or more user computers 104 either comprise a knowledge database 110 and an inference engine 112, or are connected to a separate device 108, such as a computer server, that comprises a knowledge database 110 and an inference engine 112 via a network 106.

FIG. 2 shows a flowchart 200 of a process for the creation of personalized marketing campaigns with interaction between the workflow and the marketing campaign knowledge model.

Initially, a new personalized marketing campaign workflow event may be entered by a user (202). A new or changed campaign workflow is then automatically detected (204). This could occur upon a campaign designer saving the campaign workflow, or occur dynamically as the campaign workflow is actively being created. The campaign workflow is entered by the user and the user entered campaign workflow is instantiated into the knowledge model (206).

Inferencing may then be performed to draw inferences based on the user-entered workflow information and the data contained in the knowledge model (208).

The inferences drawn may then be returned back into the workflow (210). Such injection of inferences may be, for example, any of the type described above, such as the suggestion of new instances of campaign concepts (e.g., Touchpoints, Messages, Calls-to-Action) or alerts to errors, omissions, or inconsistencies.

FIG. 3 depicts a user interface 300 that allows the user 302 to create a campaign workflow. The user interface 300 may provide the user with the ability to name the campaign workflow, and/or categorize it as a particular type of campaign vertical, such as an education campaign, e.g., in a natural language free-form field 354. The user may also be provided the ability to save and later recall and revise a particular campaign workflow, e.g., at 358.

A graphical representation of a toolbox for the creation of a campaign workflow may be provided to the user 302. Such a toolbox may include templates of model campaign flows 304, and such templates may be further categorized for different types of campaign verticals.

The Toolbox 302 may also include exemplary building blocks 306, 308, 310, 312, 314, and templates 316, 318, 320, 322, 324, 326 from which the user can select while building a campaign workflow.

The user may build the campaign workflow by selecting building blocks (e.g., 328, 330, 344, and 346) and Touchpoints (e.g. 334, 338, and 350). Specific information may be entered for each node (including both building blocks and Touchpoints) using natural language entered into free-form fields (332, 336, 340, 348, and 352).

As information is entered by the user, the inference engine draws inferences from that information and, for example, presents the user with alerts regarding errors in the creation of the workflow or omissions of information, and may offer the user suggestions for additional workflow items, such as additional Touchpoints.

The inferences drawn may be fed back into the system to facilitate the creation of additional campaign items. For example, as shown, information regarding which recipients responded to the Postcard invitation by visiting the course registration webpage is feedback 342 to identify recipients who have visited the PURL 346 and who are then targeted for an email 350 offering, e.g., more services 352.

FIG. 4 is a flowchart 400 of a process for drawing an inference from semantic data entered by the user and guiding the user in the creation of the Product Offer marketing campaign based on that inference. First, the user creates a campaign node and enters the text “postcard” into a free-form field (402). The Inference Engine then checks “postcard” against the semantic definitions of concepts in the Knowledge Database (404). The Inference Engine Identifies “postcard” as matching a semantic definition of the concept Touchpoint, which contains a “Message” (406). Next, the Inference Engine identifies other content that may or must be included to send a Message, for example, a recipient address information or coupon information (408). The inference engine may check the campaign data to determine whether such content has already been included by the user (410). Finally, the inference engine alerts the user that it appears that the user is creating a Message and suggests including a coupon and/or recipient address information.

FIG. 5 is an example of a campaign workflow case study, which may be stored in the knowledge database. The exemplary case study also demonstrates what the final product of a campaign workflow may be.

A legend 502 indicates how each type of node in a campaign workflow is represented. Each Touchpoint 502A may contain Content 502B and may indicate a Call-to-Action 502C. Each Human Action 502E may be tracked and stored as data 502F. The Timing of each node may also be indicated 502D. An Incentive 502H is provided for the Recipients to take the Calls-to-action and information about the Incentive is shown as Repeat Content 502E that appears on the Touchpoints throughout the workflow. For this example, the first Touchpoint 510 is a printed mailer, such as a postcard, sent to recipients in a database of trendy and affluent individuals 504. The Touchpoint 510 requires user-supplied content to be included in the postcard such as a PURL 512, a Passcode 506, and coupon offer information 508. The Call-to-Action 514 is a call to visit the PURL.

The first recipient human action occurs when recipients visit the PURL 516. Information regarding which recipients visited the PURL in response to the postcard invitation is then stored in a database 518.

As the user enters information for the design of the campaign workflow, the inference engine may draw inferences based on the information entered, and provide feedback to the user to facilitate the design. For example, the user typed in “Postcard”, the user may be presented a prompt suggesting that it appears that the user was seeking to send a message and prompting the user to designate the recipients and indicate the recipient contact information. As another example, when the user entered the coupon offer information content 508, the inference engine may check that the indicated coupon offer expiration date was, for example, after the current date or the expected date of mailing, and—if not—alert the user to the inconsistency. What is depicted in FIG. 5, however, is the end result of the process of designing and running a full campaign 500. The entirety of this information could be fed back into the knowledge database to improve the inferencing ability of the inference engine.

Meanwhile, a separate Touchpoint is the placement of an advertisement in one or more types of media 522. The Content supplied by the user to be included in such an advertisement, such as the pass code 524 and the coupon offer information 520, is also entered by the user.

The Touchpoint Call-to-Action is, again, visiting the PURL 526. The Human Action occurs when a recipient visits the website 528. Information regarding which recipient visited the website, and in response to an advertisement in which media may be stored in a database 530, 532, 534 as determined by the user entered Passcode.

As the user enters information for the design of the campaign workflow, the inference engine may draw inferences based on the information entered, and provide feedback to the user to facilitate the design. For example, the user typed in “Ad” or “Advertisement”, the user may be presented a prompt suggesting that it appears that the user was seeking to design an advertisement inviting people to visit a website and prompting the user to indicate varying passcodes 524 which viewers of different types of advertisements could use when accessing the website. What is depicted in FIG. 5, however, is the end result of the process of designing and running a full campaign 500. The entirety of this information could be fed back into the knowledge database to improve the inferencing ability of the inference engine.

In the exemplary campaign workflow embodiment 500 depicted in FIG. 5, the next Touchpoint is the PURL Landing Page 536. This Touchpoint requires the user to supply content such as, for example, the coupon offer information 538, and the Call-to-Action is the entry of the passcode (provided by the user at 512 and 524) by the recipient of the postcard message 510 or the advertisement 524.

As the user enters information for the design of the campaign workflow, the inference engine may draw inferences based on the information entered, and provide feedback to the user to facilitate the design. For example, the user entered a Call-to-Action of “enter passcode” the inference engine may check to see whether such passcodes were actually supplied by each of the communications to the recipients, e.g., that for each advertisement 522 and each postcard Invitation Message 510 the user supplied the passcodes as necessary content information, as is depicted at 506 and 524. FIG. 5 depicts the end result of the process of designing and running a full campaign 500. The entirety of this information could be fed back into the knowledge database to improve the inferencing ability of the inference engine.

Once the recipient enters the passcode at 542, the recipient is presented with the next Touchpoint designed by the user, a survey web page 544. For the Survey Web Page 544 of the depicted embodiment, the user has supplied survey content information 546, and indicated a Call-to-Action wherein the recipient is called upon to complete the survey 548.

As the user enters information for the design of the campaign workflow, the inference engine may draw inferences based on the information entered, and provide feedback to the user to facilitate the design. For example, once the user indicated, for example either by selection or entering natural language in a free-form field, that the user was creating a survey, the inference engine may make suggestions as to the type of content that the user may want to include in the survey content 546. Additionally, the inference engine may suggest that the user include the additional Touchpoint 552 of sending an email “Thank You” message along with the coupon once the recipient has completed the survey 550, as an additional Touchpoint the user may have neglected to include. The inference engine may also check to ensure that the survey 544 requests the recipient's email address as part of the content of the survey 546, and, if not, alert the user that that such information has been omitted. FIG. 5 is the end result of the process of designing and running a full campaign 500. The entirety of this information could be fed back into the knowledge database to improve the inferencing ability of the inference engine.

Once the recipient has completed the survey 550, the final Touchpoint depicted in the exemplary embodiment of a campaign workflow 500 depicted in FIG. 5 is the sending of a “Thank You” email Message along with the Incentive (e.g. coupon). The coupon, for example, may be supplied by the user 554. The email “Thank You” message also includes a Call-to-Action calling for the recipient to visit the business 556, which happens to be a restaurant in the exemplary embodiment of a campaign workflow 500 depicted in FIG. 5. This example ends with the Human Action of the recipient actually visiting the restaurant and redeeming the coupon 558. When a user indicates that a Touchpoint delivers an Incentive, the inference engine may suggest that the user include Content for the information about the Incentive on all previous Touchpoints in the campaign workflow. For instance, if the user had not previously specified Content 508, 520, and 538, upon user creation of Incentive 554, the inference engine would suggest the addition of said Content.

As the user enters information for the design of the campaign workflow, the inference engine may draw inferences based on the information entered, and provide feedback to the user to facilitate the design. For example, the user typed in “Postcard”, the user may be presented a prompt suggesting that it appears that the user was seeking to send a message and prompting the user to designate the recipients and indicate the recipient contact information. As another example, when the user entered the coupon offer information content 508, the inference engine may check that the indicated coupon offer expiration date was, for example, after the current date or the expected date of mailing, and—if not—alert the user to the inconsistency. FIG. 5 depicts the end result of the process of designing and running a full campaign 500. The entirety of this information could be fed back into the knowledge database to improve the inferencing ability of the inference engine.

Through the use of the semantic infrastructure described above, an automated assistance may be provided in the form of visualizations of the content and messaging that a specified campaign design requires—both the explicit and implicit requirements. These visualizations are dynamically and automatically generated as a campaign is created. Although most useful for the graphic designer and the marketer, the other participants in the campaign creation may find these visualizations useful as well.

As the campaign is collaboratively created, it is instantiated into the knowledge base and the automated reasoning (i.e., the logic, rules, queries, algorithmic modules, etc.) is executed over the campaign. The resulting inferences determine the implicit requirements about the campaign. The explicit and implicit requirements are both analyzed to construct a visualization for each Touchpoint in the campaign. Each visualization is associated within the campaign creation application and can be viewed by a user to graphically see the requirements for that Touchpoint.

The visualizations are generally intended to convey the explicit and implicit content and messaging of the campaign Touchpoints. They are not necessarily intended to produce specific graphic art or a particular layout of the content.

Set forth below is a non-exhaustive list of examples for visualization of the campaign requirements.

A first example is channel-appropriate templates. When a Touchpoint's Channel (e.g., E-mail, Blog, Print, Mobile, Web, etc.) is asserted or inferred, a corresponding template may be selected for the type of channel in which to display the campaign Touchpoint's content and messages. Otherwise, a generic template is used.

A second example is Calls-to-Action and Incentive summaries. The vast majority of personalized marketing campaigns use some Incentive to encourage the campaign Recipients to perform one or more Calls-to-Action. The previously described knowledge model provides the capability to express which Touchpoint in the campaign workflow “qualifies” the Recipient to receive the Incentive. The knowledge model “knows” that all Touchpoints previous to the “qualifying” Touchpoint must have their Calls-to-Action performed as well.

A campaign designer could specify via an application that a particular Touchpoint in the workflow will qualify the Recipient for the Incentive. This would be instantiated into the knowledge model. The automated reasoning system would then auto-generate a natural language message to the Recipient about which actions will need to be taken to receive the Incentive. The visualization of the Touchpoint would render the message of the Calls-to-Action a Recipient is required to perform (e.g., “Visit your personalized web site, complete our survey, and register for a demo to be entered in a contest to win a Cruise For Two”, etc.). Additionally, each Touchpoint visualization could also render content about the Incentive (e.g., “Two Week Greek Cruise For Two . . . ”, etc.)

A third example is sample information content. A campaign design application may support the capability for users to associate various types of Informational Content (Invitation Code, QR Code, SMS Response Number, PURL, Personalized Images, Barcode, Driving Directions, Mailing Address, etc.) with a Touchpoint. Much of this content is personalized and the specific values will not be determined until campaign execution with provided variable-data logic and Recipient data sources. Additionally, the knowledge model can infer that certain Information Content must exist based on other explicit requirements during campaign creation (such as the user specified Calls-to-Action, Message, Tracking, etc.). The explicit or implicit Informational Content is rendered in the Touchpoint visualization with a sample of that content (e.g., a sample Invitation Code, QR Code, PURL, etc.).

A fourth example is sample Touchpoint type content. The knowledge model is adapted to infer that a Touchpoint is a specific type of Touchpoint. These Touchpoint types may include, for example, Invitation, Product Offer, Reminder, Registration, Donation Request, Survey, Contact Verification Confirmation, Thank You, and the like. When the Touchpoint type is explicitly specified in the campaign creation application or inferred via the supporting knowledge model and its automated reasoning, sample content or messaging in the Touchpoint's visualization that corresponds to the Touchpoint's type may be rendered. For example, a Touchpoint Survey could render a sample Survey form, a Touchpoint Contact_Verification could render a Recipient Info Contact Form, a Touchpoint Invitation could render a sample ‘Invite message’, a Touchpoint Reminder could render a sample ‘Reminder message’, and/or a Touchpoint Thank_You could render a sample ‘Thank You message’.

The visualization can also be automatically populated with annotations that describe its sample renderings. The annotation conveys to the user how said method described herein has determined to render the particular content or message in the visualization. The annotation may simply state that it was user specified, or it may provide a more detailed description of which aspect of the Touchpoint(s) causes the content or message to be inferred to exist.

FIG. 6 shows a flowchart of an exemplary method of automatically generating a template, example, or outline of a document in a marketing campaign design environment. Initially, an identification of a specified Touchpoint of the plurality of Touchpoints in a campaign is received (601). The specified Touchpoint and its elements are instantiated into a knowledge model (602). A semantic inferencing engine is executed to determine inferences based on the plurality of Touchpoints instantiated into the knowledge model (603). Inferences are transformed into implicit requirements about the contents for each of the Touchpoints (604). A representation of the specified Touchpoint is displayed on the user interface, and included within the representation of the specified Touchpoint are the Touchpoint contents as described by the explicit and implicit requirements (605).

In certain embodiments, the implicit requirements may include, for example, auto generating a natural language message describing a campaign recipient's calls-to-action, a performance of which will entitle a performer to the incentive, auto selecting sample messaging describing the inferred Touchpoint type, automatically determining the visualization template in which to use that corresponds to the explicit and implicit requirements, and/or the inferred Touchpoint elements such that the campaign conforms to marketing best practices. Further, the marketing best practices may comprise the automated inference that information about the Incentive appears on each Touchpoint in the campaign, or that campaign response tracking automatically infers that a bar code or invitation code must appear on a Touchpoint. Also, certain embodiments may further include displaying respective annotations associated with respective portions of the auto generated content and natural language messaging, wherein the annotations identify at least one of a source of and a reason for, the inclusion of the respective portion of the auto generated content and natural language messaging.

FIG. 7 shows a sample rendering of a Touchpoint 702 in a campaign workflow in accordance with aspects of the exemplary method. In this case, the Touchpoint 702 is an e-mail that thanks the recipient for a previous purchase. The e-mail consists of several Calls-to-Action 704, which lead the recipient 706 to receive a discount on their next purchase. The annotations 708 may be specified in colored bubbles (e.g., blue). The bubbles could appear, for example, as the user clicks or hovers over content rendered in the sample.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of the above-described methods. The program storage devices may be, e.g., flash or thumb drives, digital memories, magnetic storage media such as a magnetic disks and magnetic tapes, hard drives, or optically readable digital data storage media. The embodiments are also intended to cover computers programmed to perform the steps of the above-described methods.

Further, the exemplary embodiments may be implemented in a computer program product that may be executed on a computing device. The computer program product may be a non-transitory computer-readable recording medium on which a control program is recorded, such as a disk, hard drive, or may be a transmittable carrier wave in which the control program is embodied as a data signal. Common forms of computer-readable media include, for example, flash drives, thumb drives, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, transmission media, such as acoustic or light waves, such as those generated during radio wave and infrared data communications, and the like, or any other medium from which a computer can read and use.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A computer-implemented method of automatically generating a template, example, or outline of a document in a marketing campaign design environment, the method comprising:
receiving an identification of a specified Touchpoint of the plurality of Touchpoints in a campaign;
instantiating the specified Touchpoint and its elements into a knowledge model;
using a semantic inferencing engine to determine inferences based on the plurality of Touchpoints instantiated into the knowledge model;
transforming inferences into implicit requirements about the contents for each of the Touchpoints; and
displaying a representation of the specified Touchpoint, wherein included within the representation of the specified Touchpoint are the Touchpoint contents as described by the explicit and implicit requirements.

2. The method according to claim 1, wherein the implicit requirements include auto generating a natural language message describing a campaign recipient's calls-to-action, a performance of which will entitle a performer to the incentive;

3. The method according to claim 1, wherein the implicit requirements include auto selecting sample messaging describing the inferred Touchpoint type

4. The method according to claim 1, wherein the implicit requirements include automatically determining the visualization template in which to use that corresponds to the explicit and implicit requirements

5. The method according to claim 1, wherein the implicit requirements include the inferred Touchpoint elements such that the campaign conforms to marketing best practices

6. The method according to claim 5, wherein the marketing best practices comprise the automated inference that information about the Incentive appears on each Touchpoint in the campaign, or that campaign response tracking automatically infers that a bar code or invitation code must appear on a Touchpoint.

7. The method of according to claim 1, further comprising:
displaying respective annotations associated with respective portions of the auto generated content and natural language messaging, wherein the annotations identify at least one of a source of and a reason for, the inclusion of the respective portion of the auto generated content and natural language messaging.

8. A system for automatically generating a template, example, or outline of a document in a marketing campaign design environment, the system comprising:
one or more processors configured for:
receiving an identification of a specified Touchpoint of the plurality of Touchpoints in a campaign;
instantiating the specified Touchpoint and its elements into a knowledge model;
using a semantic inferencing engine to determine inferences based on the plurality of Touchpoints instantiated into the knowledge model;
inferences are transformed into implicit requirements about the contents for each of the Touchpoints;
displaying a representation of the specified Touchpoint; and
displaying a representation of the specified Touchpoint, wherein included within the representation of the specified Touchpoint are the Touchpoint contents as described by the explicit and implicit requirements.

9. The system according to claim 8, wherein the implicit requirements include auto generating a natural language message describing a campaign recipient's calls-to-action, a performance of which will entitle a performer to the incentive;

10. The system according to claim 8, wherein the implicit requirements include auto selecting sample messaging describing the inferred Touchpoint type

11. The system according to claim 8, wherein the implicit requirements include automatically determining the visualization template in which to use that corresponds to the explicit and implicit requirements

12. The system according to claim 8, wherein the implicit requirements include the inferred Touchpoint elements such that the campaign conforms to marketing best practices (e.g. the automated inference that information about the Incentive appears on each Touchpoint in the campaign, or e.g. that campaign response tracking automatically infers that a bar code or invitation code must appear on a Touchpoint.)

13. The system according to claim 12, wherein the marketing best practices comprise the automated inference that information about the Incentive appears on each Touchpoint in the campaign, or that campaign response tracking automatically infers that a bar code or invitation code must appear on a Touchpoint.

14. The system according to claim 8, wherein the one or more processors are further configured for:
displaying respective annotations associated with respective portions of the auto generated content and natural language messaging, wherein the annotations identify at least one of a source of and a reason for, the inclusion of the respective portion of the auto generated content and natural language messaging.

15. A non-transitory computer-usable data carrier storing instructions that, when executed by a computer, cause the computer to perform a method of automatically generating a template, example, or outline of a document in a marketing campaign design environment, wherein the method comprises:
receiving an identification of a specified Touchpoint of the plurality of Touchpoints in a campaign;
instantiating the specified Touchpoint and its elements into a knowledge model;
using a semantic inferencing engine to determine inferences based on the plurality of Touchpoints instantiated into the knowledge model;
transforming inferences into implicit requirements about the contents for each of the Touchpoints; and
displaying a representation of the specified Touchpoint, wherein included within the representation of the specified Touchpoint are the Touchpoint contents as described by the explicit and implicit requirements.

16. The non-transitory computer-usable data carrier of claim 15, wherein the implicit requirements include auto generating a natural language message describing a campaign recipient's calls-to-action, a performance of which will entitle a performer to the incentive;

17. The non-transitory computer-usable data carrier of claim 15, wherein the implicit requirements include auto selecting sample messaging describing the inferred Touchpoint type

18. The non-transitory computer-usable data carrier of claim 15, wherein the implicit requirements include automatically determining the visualization template in which to use that corresponds to the explicit and implicit requirements

19. The non-transitory computer-usable data carrier of claim 15, wherein the implicit requirements include the inferred Touchpoint elements such that the campaign conforms to marketing best practices and wherein the marketing best practices comprise the automated inference that information about the Incentive appears on each Touchpoint in the campaign, or that campaign response tracking automatically infers that a bar code or invitation code must appear on a Touchpoint.

20. The non-transitory computer-usable data carrier of claim 15, wherein the method further comprises:
displaying respective annotations associated with respective portions of the auto generated content and natural language messaging, wherein the annotations identify at least one of a source of and a reason for, the inclusion of the respective portion of the auto generated content and natural language messaging.
